(19) United States
(12) Patent Application Publication
(10) Pub. No.: US 2021/0172214 A1
(43) Pub. Date: Jun. 10, 2021

(54) APPARATUS FOR OPENING/CLOSING FUEL LID OF VEHICLE

(71) Applicant: Sinjin Plastics Co., Ltd., Incheon (KR)

(72) Inventor: Byungsang Kim, Bucheon-si (KR)

(21) Appl. No.: 16/859,596

(22) Filed: Apr. 27, 2020

(30) Foreign Application Priority Data
Dec. 4, 2019 (KR) 10-2019-0159709

(51) Int. Cl. E05B 81/34; E05B 83/34; E05B 81/20

(52) U.S. Cl. CPC E05B 81/34; E05Y 2900/534; E05B 81/20; E05B 83/34

(57) ABSTRACT

The described technology relates to an apparatus for opening/closing a fuel lid of a vehicle. In one aspect, the apparatus includes a housing, a push rod configured to reciprocate between a fuel lid open position and a fuel lid closed position, and a locking part configured to lock the push rod. The locking part may include a drive motor configured to rotate in forward and reverse directions to correspond to the fuel lid open and closed positions. The locking part may also include a pinion gear mounted on a shaft of the drive motor, and a linear moving body configured to linearly reciprocate by the rotation of the pinion gear in the forward and reverse directions. The locking part may further include a locking recess formed on an outer surface of the push rod, the locking protrusion configured to be locked to or unlocked from the locking recess.

### CROSS-REFERENCE TO RELATED APPLICATIONS

A claim for priority under 35 U.S.C. § 119 is made to Korean Patent Application No. 10-2019-0159709 filed Dec. 4, 2019 in the Korean Intellectual Property Office, the entire contents of which are hereby incorporated by reference.

### BACKGROUND

### Field

The described technology generally relates to an apparatus for opening/closing a fuel lid of a vehicle.

### Description of Related Technology

In general, a fuel lid is opened or closed by a hinge and is mounted on a vehicle such that in a closed position, the fuel lid closes a fueling opening and the surface of the fuel lid coincides with the contour of a vehicle body.

A fueling port on which a cap is mounted is disposed in the fueling opening. To prevent the fuel lid from being unintentionally opened, the fuel lid is locked.

### SUMMARY

One aspect is a vehicle fuel lid opening/closing apparatus for simplifying a structure for opening/closing a fuel lid, decreasing the number of parts to achieve a reduction in the number of assembly steps and an improvement in assembly efficiency, and making the apparatus compact.

Another aspect is an apparatus for opening/closing a fuel lid of a vehicle includes a housing, a push rod that is provided in the housing and that reciprocates between an open position in which the fuel lid of the vehicle is opened and a closed position in which the fuel lid of the vehicle is closed, and a locking part that locks the push rod such that the push rod does not move from the closed position to the open position. The locking part includes a drive motor that is received in the housing and that rotates in forward and reverse directions to correspond to the open position and the closed position, a pinion gear that is mounted on a shaft of the drive motor and that rotates in the forward and reverse directions, a linear moving body having a plurality of gear teeth formed to be engaged with the pinion gear in one direction and a locking protrusion protruding toward the push rod, in which the linear moving body linearly reciprocates by the rotation of the pinion gear in the forward and reverse directions, a locking recess formed on part of an outer circumferential surface of the push rod, the locking protrusion being locked to the locking recess, and a guide part that guides linear reciprocation of the linear moving body in a direction perpendicular to an axis line of the push rod.

The guide part may include a guide protrusion protruding from one of the housing and the linear moving body along a direction perpendicular to the push rod and a guide track that is provided on the other of the housing and the linear moving body along the direction perpendicular to the push rod and that guides a movement of the guide protrusion.

The linear moving body may have a gear receiving hole formed therein in which the pinion gear is received, the gear receiving hole having a long hole shape, and the plurality of gear teeth may be formed on the remaining inner surfaces other than one side of the gear receiving hole.

The apparatus may further include a rotary rod that is provided in the housing and that turns the push rod relative to the housing when the push rod repeatedly moves between the open position and the closed position. A helical path may be formed on an outer circumference of the rotary rod to correspond to a linear travel distance of the push rod for the open position and the closed position, and the push rod may have a tappet that is formed on the outer circumferential surface thereof and that moves along the helical path to turn the push rod.

The apparatus may further include an elastic member that is received inside the rotary rod and the push rod and that exerts an elastic force on the push rod to move the push rod to the open position.

The apparatus may further include a damper provided on an end portion of the linear moving body that is on the opposite side to the locking protrusion, in which the damper relieves impact when the linear moving body collides with the housing.

### BRIEF DESCRIPTION OF THE FIGURES

The above and other objects and features will become apparent from the following description with reference to the following figures, wherein like reference numerals refer to like parts throughout the various figures unless otherwise specified.

FIG. 1 is a perspective view of a fuel lid opening/closing apparatus for a vehicle according to an embodiment of the described technology.

FIG. 2 is a sectional perspective view of major parts in FIG. 1.

FIG. 3 is an exploded perspective view of the major parts in FIG. 1.

FIG. 4 is a sectional view taken along line A-A of FIG. 1.

FIG. 5 is a perspective view of a linear moving body in FIG. 3.

FIG. 6 is a sectional view illustrating a state in which a push rod of FIG. 1 is located in an open position.

FIG. 7 is a vertical sectional view of FIG. 6.

FIG. 8 is a sectional view illustrating a state in which the push rod of FIG. 1 is located in a closed position.

FIG. 9 is a vertical sectional view of FIG. 8.

### DETAILED DESCRIPTION

An example fuel lid opening/closing apparatus is disclosed in Japanese Patent Application Publication No. 2016-223150. In the disclosed fuel lid opening/closing apparatus, when a push rod moves downward to close a fuel lid, a stopping member engaged to rotate together with a rotary gear integrally rotating with an output shaft of a motor is stopped by a recess of the push rod while the stopping member remains stopped by the recess of the push rod by the elastic force of a torsion spring, and accordingly the push rod is not raised.

However, in the fuel lid opening/closing apparatus, the stopping member is stopped by the recess of the push rod while rotating in the state of being engaged with the rotary gear integrally rotating with the output shaft of the motor. Furthermore, the stopping member is elastically supported by the elastic force of the torsion spring so as to be stopped without being separated from the recess of the push rod. Therefore, the structure for opening/closing the fuel lid is complex, and due to a number of parts, assembly work is not easy so that the number of assembly steps is increased. Especially, the apparatus is large in size because the radius of rotation of the stopping member in a narrow space has to be ensured.

Embodiments will be described in conjunction with the accompanying drawings. However, the described technology is not limited to the embodiments disclosed herein and may be implemented in various different forms. Herein, the embodiments are provided to provide complete disclosure of the described technology and to provide thorough understanding of the described technology to those skilled in the art to which the described technology pertains, and the scope of the inventive concept should be limited only by the accompanying claims and equivalents thereof.

Terms used herein are only for description of embodiments and are not intended to limit the inventive concept. As used herein, the singular forms are intended to include the plural forms as well, unless context clearly indicates otherwise. It will be further understood that the terms “comprise” and/or “comprising” specify the presence of stated features, components, and/or operations, but do not preclude the presence or addition of one or more other features, components, and/or operations. In addition, identical numerals will denote identical components throughout the specification, and the meaning of “and/or” includes each mentioned item and every combination of mentioned items. It will be understood that, although the terms first, second, etc. may be used herein to describe various components, these components should not be limited by these terms. These terms are only used to distinguish one component from another component. Thus, a first component discussed below could be termed a second component without departing from the teachings of the inventive concept.

Unless otherwise defined, all terms (including technical and scientific terms) used herein have the same meaning as commonly understood by those skilled in the art to which the described technology pertains. It will be further understood that terms, such as those defined in commonly used dictionaries, should not be interpreted in an idealized or overly formal sense unless expressly so defined herein.

Hereinafter, embodiments of the described technology will be described in detail with reference to the accompanying drawings.

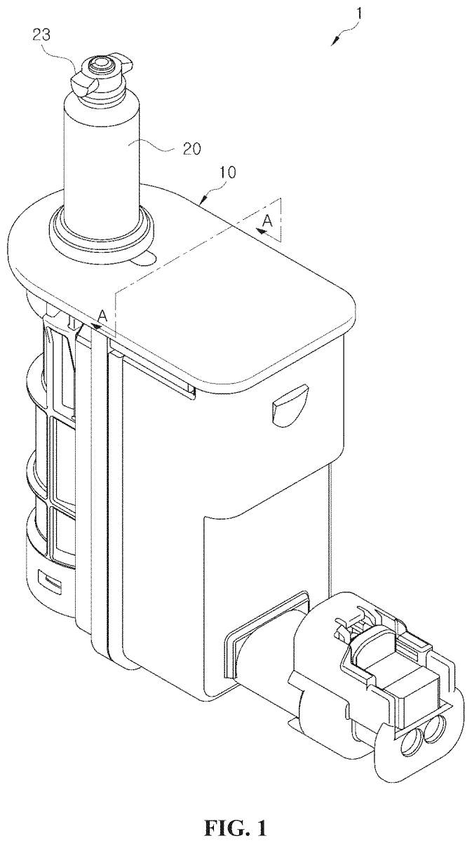

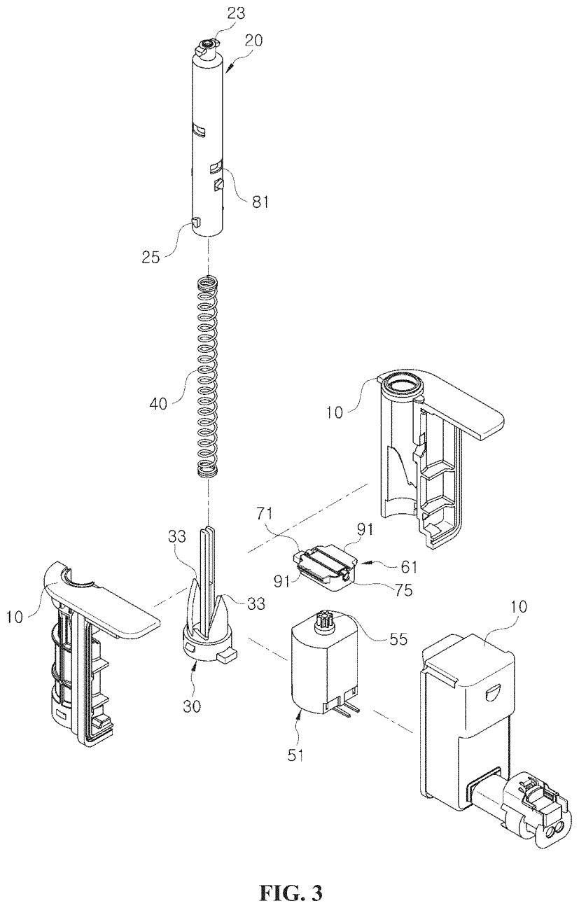

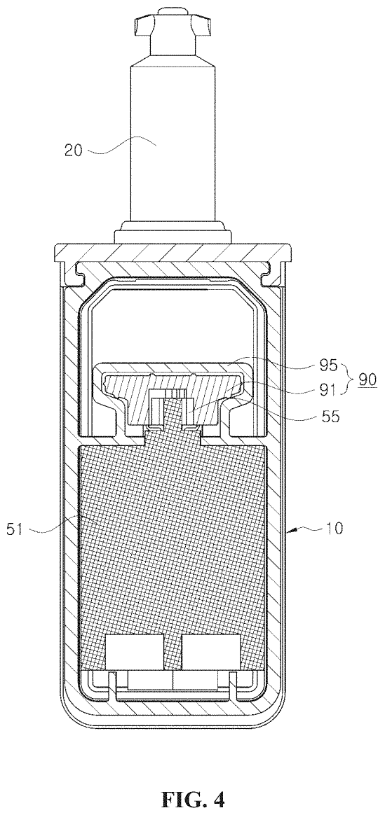

FIGS. 1 to 5 illustrate a fuel lid opening/closing apparatus for a vehicle according to an embodiment of the described technology.

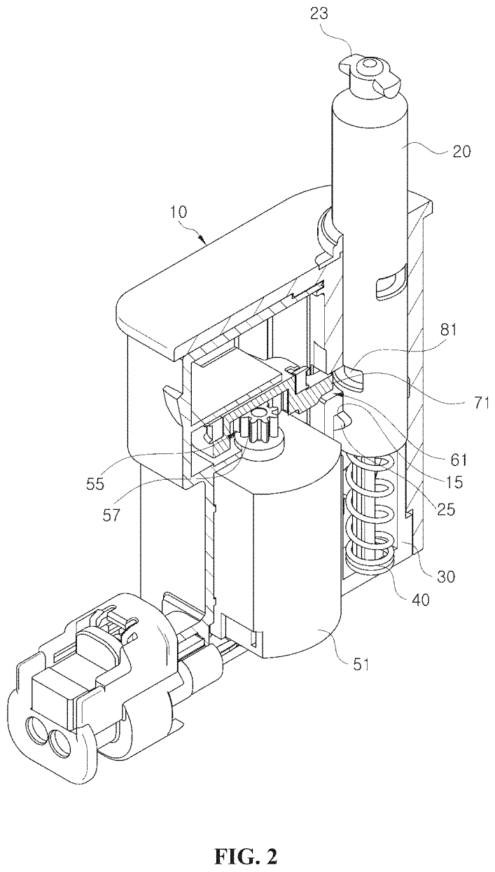

As illustrated in these drawings, the vehicle fuel lid opening/closing apparatus 1 according to the embodiment of the described technology includes a housing 10, a push rod 20, and a locking part (not shown in FIG. 1 and to be described with respect to FIGS. 2-5).

The housing 10 has a hollow container shape and has a structure that can be divided into left and right parts.

The push rod 20 is received on one side of the housing 10, and a drive motor 51 that will be described below is received on an opposite side of the housing 10.

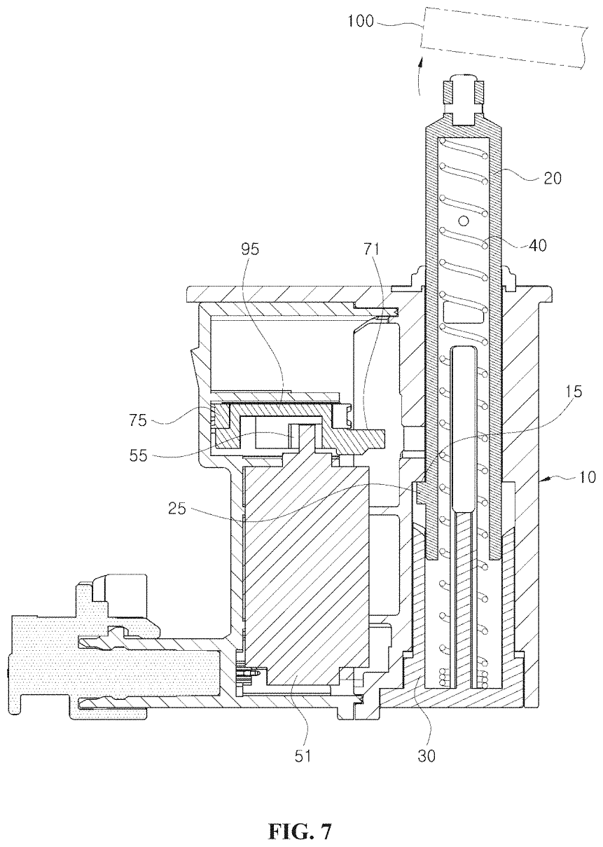

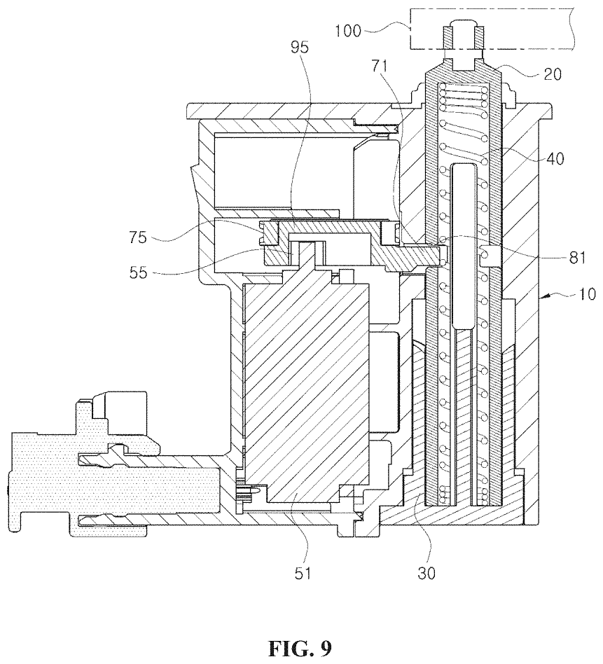

The push rod 20 has a rod shape with a predetermined length and is provided on the one side of the housing 10 so as to reciprocate. The push rod 20 reciprocates between an open position in which a fuel lid 100 (refer to FIGS. 7 and 9) of the vehicle is opened and a closed position in which the fuel lid 100 is closed.

One end portion of the push rod 20 is exposed outside the housing 10, and an opposite end portion of the push rod 20 is received in a rotary rod 30, which will be described below, so as to move inward or outward.

The push rod 20 includes, on the one end portion thereof, a locking protrusion 23 for the fuel lid 100. The locking protrusion 23 is locked with the fuel lid 100 in the closed position in which the fuel lid 100 of the vehicle closes a fueling opening (not illustrated). The locking protrusion 23 is unlocked from the fuel lid 100 in the open position in which the fuel lid 100 of the vehicle opens the fueling opening.

The push rod 20 repeatedly moves between the open position and the closed position while being turned by the rotary rod 30.

The rotary rod 30 is provided in the housing 10, and the opposite end portion of the push rod 20 is received in the rotary rod 30 so as to move inward or outward.

A helical path 33 is formed on an outer circumference of the rotary rod 30 by cutting away a portion of the rotary rod 30.

The helical path 33 has a length corresponding to a linear travel distance of the push rod 20 for the open position and the closed position of the push rod 20, for example, the amount by which the push rod 20 pops up.

Meanwhile, the push rod 20 has, on an outer circumferential surface thereof, a tappet 25 that moves along the helical path 33 to turn the push rod 20.

When the push rod 20 repeatedly moves between the open position and the closed position, the tappet 25 slides along the helical path 332, and accordingly the push rod 20 turns relative to the housing 10 in forward and reverse directions.

When the push rod 20 is located in the open position, the tappet 25 is stopped by a stopper recess 15 formed on the housing 10, and the push rod 20 no longer moves upward relative to the housing 10.

Furthermore, when the push rod 20 is located in the closed position, the tappet 25 is brought into close contact with a bottom surface of the rotary rod 30, and the push rod 20 no longer moves downward relative to the housing 10.

Meanwhile, an elastic member 40 is received between the rotary rod 30 and the push rod 20. The elastic member 40 is partly received inside the push rod 20 at the same time as being partly received inside the rotary rod 30. Accordingly, the elastic member 40 exerts an elastic force on the push rod 20 such that the push rod 20 moves to the open position.

Here, in this embodiment, a coil spring is illustrated as the elastic member 40. Without being limited thereto, however, the elastic member 40 may be implemented with various forms of elastic bodies capable of generating an elastic force as the elastic member 40.

The locking part locks the push rod 20 such that the push rod 20 does not move from the closed position to the open position.

The locking part includes the drive motor 51, a pinion gear 55, a linear moving body 61, a locking recess 81, and a guide part 90.

The drive motor 51 is received on the opposite side of the housing 10. The drive motor 51 is disposed such that the axis line of the drive motor 51 is parallel to the axis line of the push rod 20.

The drive motor 51 rotates in forward and reverse directions to correspond to the open position and the closed position of the push rod 20.

The pinion gear 55 has a plurality of gear teeth 57 formed on an outer circumferential surface thereof. The pinion gear 55 is mounted on a shaft of the drive motor 51 and rotates in the forward and reverse directions.

The linear moving body 61 has a rectangular block shape with a predetermined thickness.

The linear moving body 61 has a gear receiving hole 63 formed therein in which the pinion gear 55 is received.

The gear receiving hole 63 has a cross-sectional shape of a long hole that includes first and second sides disposed to face each other with an interval therebetween and opposite end portions formed to be curved with a predetermined radius of curvature between the first side and the second side. Here, the interval between the first side and the second side of the gear receiving hole 63 is greater than the diameter of the pinion gear 55.

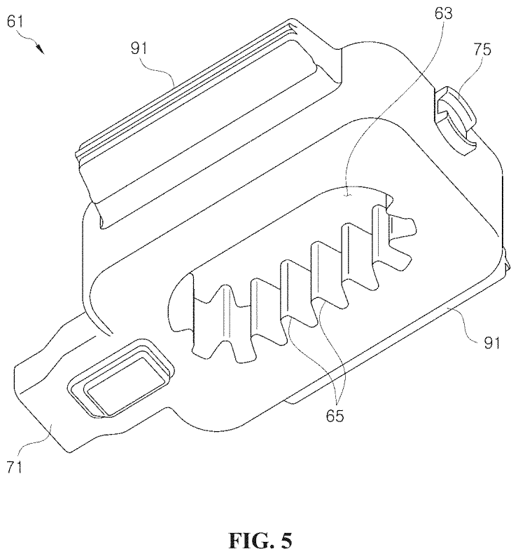

A plurality of gear teeth 65 engaged with the gear teeth 57 of the pinion gear 55 in one direction are formed in the gear receiving hole 63. In this embodiment, as illustrated in FIG. 5, the plurality of gear teeth 65 are formed on the remaining inner surfaces other than the first side of the gear receiving hole 63.

As the plurality of gear teeth 65 are formed along the second side of the gear receiving hole 63 and on the curved opposite end portions between the first side and the second side as described above, even though the pinion gear 55 rotates in a state of being located on the opposite end portions of the gear receiving hole 63, the linear moving body 61 may be prevented from moving toward the push rod 20, or moving away from the push rod 20, beyond a predetermined travel range by forward and reverse rotation of the pinion gear 55. Accordingly, linear reciprocation of the linear moving body 61 may be precisely controlled, and damage to the linear moving body 61 may be prevented.

Furthermore, a locking protrusion 71 that is locked to or unlocked from the locking recess 81 protrudes from one end portion of the linear moving body 61, for example, an end portion facing toward the push rod 20.

A damper 75 protrudes from an opposite end portion of the linear moving body 61, for example, an end portion of the linear moving body 61 that is on the opposite side to the locking protrusion 71. The damper 75 is formed of a rubber or sponge material.

Accordingly, when the linear moving body 61 moves away from the push rod 20 to a maximum travel range, the damper 75 reduces noise caused by collision with the housing 10 and relieves impact applied to the housing 10.

The locking recess 81 is concavely formed on part of the outer circumferential surface of the push rod 20 and has a predetermined width. When the push rod 20 is turned and located in the closed position, the locking recess 81 is disposed toward the locking protrusion 71 of the linear moving body 61. When the push rod 20 is turned and located in the closed position, the locking protrusion 71 is locked to the locking recess 81, and when the locking protrusion 71 is unlocked from the locking recess 81, the push rod 20 deviates from the closed position while turning.

As described above, the locking protrusion 71 of the locking part is firmly locked by the locking recess 81, and thus the push rod 20 is not easily moved from the closed position to the open position by an external force and is stably locked.

The guide part 90 guides linear reciprocation of the linear moving body 61 in a direction crossing (e.g., perpendicular to) the axis line of the push rod 20.

The guide part 90 includes guide protrusions 91 and a guide track 95.

The guide protrusions 91 are formed on opposite sides of the linear moving body 61 along the lengthwise direction of the linear moving body 61 that is crossing (e.g., perpendicular to) the push rod 20.

The guide track 95 is formed in the housing 10 in the direction perpendicular to the axis line of the push rod 20. The guide track 95 not only surrounds the guide protrusions 91 to guide reciprocation of the guide protrusions 91, but also surrounds the linear moving body 61 to guide reciprocation of the linear moving body 61. Accordingly, the linear moving body 61 stably moves toward or away from the push rod 20 while being guided by the guide track 95.

Here, in this embodiment, it has been exemplified that the guide track 95 guides reciprocation of the linear moving body 61 while surrounding the linear moving body 61 and the guide protrusions 91. Without being limited thereto, however, the guide track 95 may guide reciprocation of the linear moving body 61 while surrounding only the guide protrusions 91.

A process of opening or closing the fuel lid 100 using the vehicle fuel lid opening/closing apparatus 1 according to the embodiment of the described technology will be described below.

First, a process of switching the fueling opening from the open position to the closed position will be described.

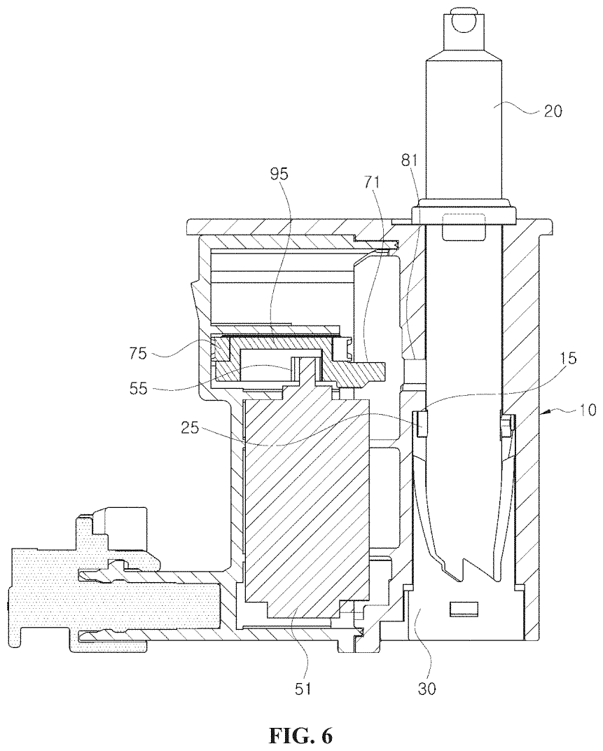

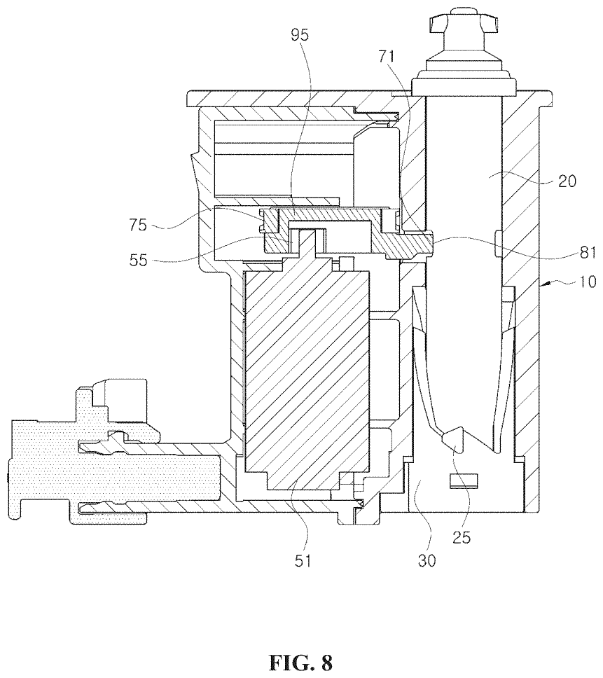

When the push rod 20 is pressed toward the housing 10 in a state in which the push rod 20 is located in the open position as illustrated in FIGS. 6 and 7, the tappet 25 of the push rod 20 located on an upper end of the rotary rod 30 slides along the helical path 33, and the push rod 20 moves down toward a lower end of the rotary rod 30 while turning about the center axis line of the rotary rod 30. The tappet 25 of the push rod 20 is located on the bottom surface of the rotary rod 30, and the push rod 20 is located in the closed position as illustrated in FIGS. 8 and 9.

At this time, the locking recess 81 formed on the push rod 20 is disposed toward the locking protrusion 71 of the linear moving body 61, and the elastic member 40 is compressed.

Further, when the drive motor 51 rotates in one direction, the pinion gear 55 rotates in the gear receiving hole 63 of the linear moving body 61 in the one direction, the linear moving body 61 is guided by the guide protrusions 91 and the guide track 95 of the guide part 90 so as to move toward the push rod 20 in the direction perpendicular to the axis line of the push rod 20, and the locking protrusion 71 of the linear moving body 61 is locked to the locking recess 81 formed on the push rod 20.

Accordingly, the fuel lid 100 connected to the push rod 20 stably closes the fueling opening, and the push rod 20 and the fuel lid 100 remain in the closed position.

Next, a process of switching the fueling opening from the closed position to the open position will be described.

When the drive motor 51 is rotated in an opposite direction in the state in which the push rod 20 is located in the closed position as illustrated in FIGS. 8 and 9, the pinion gear 55 rotates in the gear receiving hole 63 of the linear moving body 61 in the opposite direction, the linear moving body 61 is guided by the guide protrusions 91 and the guide track 95 of the guide part 90 so as to move away from the push rod 20 in the direction perpendicular to the axis line of the push rod 20, and the locking protrusion 71 of the linear moving body 61 is unlocked from the locking recess 81 formed on the push rod 20.

At this time, the push rod 20 is moved away from the rotary rod 30 by a tensile force of the elastic member 40. That is, the tappet 25 of the push rod 20 that is located on the lower end of the rotary rod 30 slides along the helical path 33, and the push rod 20 moves up toward the upper end of the rotary rod 30 while turning about the center axis line of the rotary rod 30. The tappet 25 of the push rod 20 is stopped by the stopper recess 15 of the housing 10, and the push rod 20 no longer moves upward relative to the housing 10.

Accordingly, the push rod 20 is located in the open position as illustrated in FIGS. 6 and 7, and the fuel lid 100 connected to the push rod 20 opens the fueling opening.

As described above, according to the described technology, the linear moving body 61 having the locking protrusion 71 formed thereon linearly moves toward or away from the push rod 20 by forward or reverse rotation of the pinion gear 55 mounted on the drive motor 51, and the locking protrusion 71 of the linear moving body 61 is locked to or unlocked from the locking recess 81 formed on the push rod 20 depending on the closed position or the open position of the push rod 20. Accordingly, the structure for opening/closing the fuel lid 100 may be simplified. Furthermore, the number of parts may be decreased, which results in a reduction in the number of assembly steps and an improvement in assembly efficiency. In addition, the apparatus may be made compact.

According to the described technology, the structure for opening/closing the fuel lid may be simplified. Furthermore, the number of parts may be decreased, which results in a reduction in the number of assembly steps and an improvement in assembly efficiency. In addition, the apparatus may be made compact.

While the described technology has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An apparatus for opening/closing a fuel lid of a vehicle, the apparatus comprising:
a housing;
a push rod disposed in the housing and configured to reciprocate between an open position in which the fuel lid of the vehicle is opened and a closed position in which the fuel lid of the vehicle is closed; and
a locking part configured to lock the push rod such that the push rod does not move from the closed position to the open position,
wherein the locking part includes:
a drive motor disposed in the housing and configured to rotate in forward and reverse directions to correspond to the open position and the closed position;
a pinion gear mounted on a shaft of the drive motor and configured to rotate in the forward and reverse directions;
a linear moving body comprising a plurality of gear teeth configured to be engaged with the pinion gear in one direction and a locking protrusion protruding toward the push rod, the linear moving body being configured to linearly reciprocate by the rotation of the pinion gear in the forward and reverse directions;
a locking recess formed on a portion of an outer circumferential surface of the push rod, the locking protrusion configured to be locked to or unlocked from the locking recess; and
a guide part configured to guide linear reciprocation of the linear moving body in a direction crossing an axis line of the push rod.

2. The apparatus of claim 1, wherein the guide part includes:
a guide protrusion protruding from one of the housing and the linear moving body along a direction crossing the push rod; and
a guide track disposed on the other of the housing and the linear moving body along the direction crossing the push rod and configured to guide a movement of the guide protrusion.

3. The apparatus of claim 1, wherein the linear moving body has a gear receiving hole formed therein and configured to receive the pinion gear, the gear receiving hole having a long hole shape, and
wherein the plurality of gear teeth are formed on an entire inner surface of the gear receiving hole except for one side of the gear receiving hole.

4. The apparatus of claim 1, further comprising:
a rotary rod disposed in the housing and configured to turn the push rod relative to the housing when the push rod repeatedly moves between the open position and the closed position,
wherein a helical path is formed on an outer circumference of the rotary rod to correspond to a linear travel distance of the push rod for the open position and the closed position, and
wherein the push rod has a tappet formed on the outer circumferential surface thereof, the tappet being configured to move along the helical path to turn the push rod.

5. The apparatus of claim 1, further comprising:
an elastic member disposed inside the rotary rod and the push rod and configured to exert an elastic force on the push rod to move the push rod to the open position.

6. The apparatus of claim 1, further comprising:
a damper disposed on an end portion of the linear moving body and configured to relieve impact when the linear moving body collides with the housing, the end portion of the linear moving body being on the opposite side to the locking protrusion.

7. An apparatus for opening/closing a fuel lid of a vehicle, the apparatus comprising:
a housing;
a push rod disposed in the housing and configured to reciprocate between an open position in which the fuel lid of the vehicle is opened and a closed position in which the fuel lid of the vehicle is closed;
a drive motor disposed in the housing and configured to rotate in forward and reverse directions to correspond to the open position and the closed position;
a pinion gear mounted on a shaft of the drive motor and configured to rotate in the forward and reverse directions;
a linear moving body comprising a plurality of gear teeth configured to be engaged with the pinion gear in one direction and a locking protrusion protruding toward the push rod, the linear moving body being configured to linearly reciprocate by the rotation of the pinion gear in the forward and reverse directions; and
a locking recess formed on a portion of an outer circumferential surface of the push rod, the locking protrusion configured to be locked to or unlocked from the locking recess.

8. The apparatus of claim 7, further comprising:
a guide part configured to guide linear reciprocation of the linear moving body in a direction crossing an axis line of the push rod.
